(19) United States
(12) Patent Application Publication
(10) Pub. No.: US 2015/0009617 A1
(43) Pub. Date: Jan. 8, 2015

(54) EXPANSION CARD MODULE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: XIAO-GANG YIN, Shenzhen (CN); LI-REN FU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/059,699

(22) Filed: Oct. 22, 2013

(30) Foreign Application Priority Data
Jul. 8, 2013 (CN) 2013102832332

(51) Int. Cl. G06F 1/18

(52) U.S. Cl. CPC G06F 1/186
USPC 361/679.32

(57) ABSTRACT

An electronic device includes an enclosure, a motherboard received in the enclosure, and an expansion card module received in the enclosure. The expansion card module includes a bracket, a conversion card with a connector, and an expansion card. The bracket includes a main plate and a seat. The conversion card is fixed on the main plate. The expansion card includes a circuit board plugged in the connector and a blocking piece fixed to the seat.

### BACKGROUND

1. Technical Field

The disclosure relates to an expansion card module.

2. Description of Related Art

Computer systems typically include expansion cards to expand capability. Conventionally, the expansion cards are mounted to expansion slots of the computer systems, but are easily damaged when the computer system receives shock or is impacted.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an electronic device, wherein the electronic device includes an expansion card module.

FIG. 2 is similar to FIG. 1, but viewed from another aspect.

FIG. 3 is a partially assembled view of the electronic device of FIG. 2.

FIG. 4 is an assembled, isometric view of the electronic device of FIG. 1.

FIG. 5 is an assembled, isometric view of the electronic device of FIG. 2.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

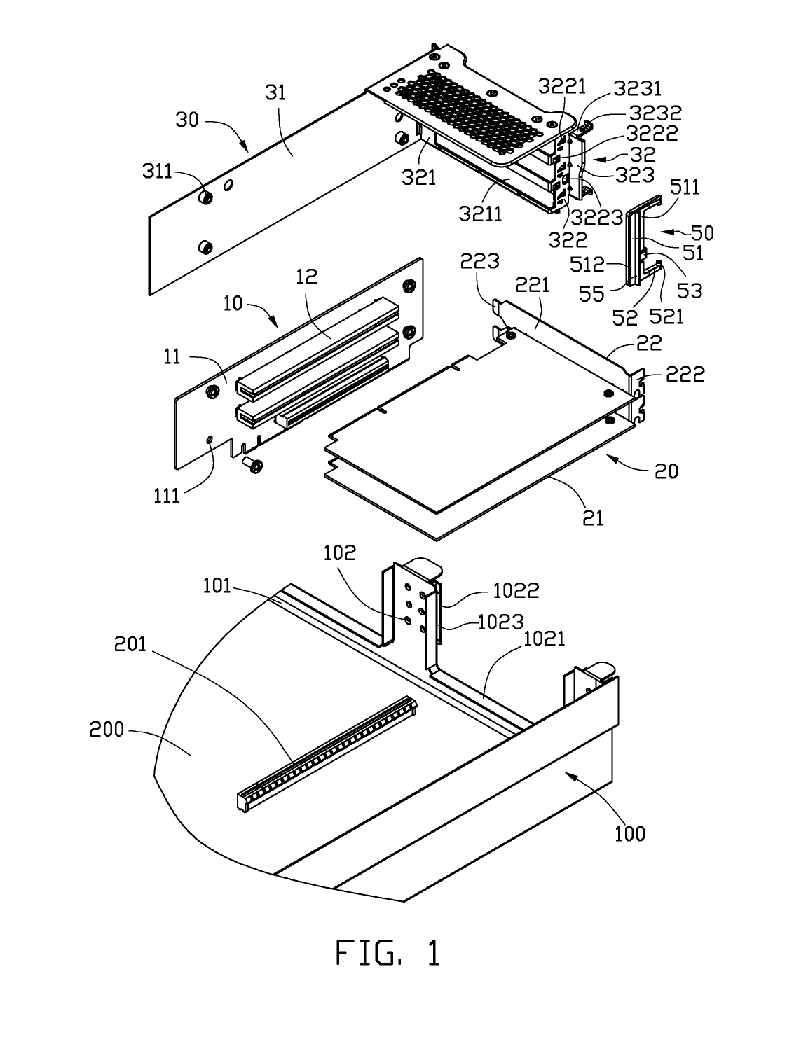

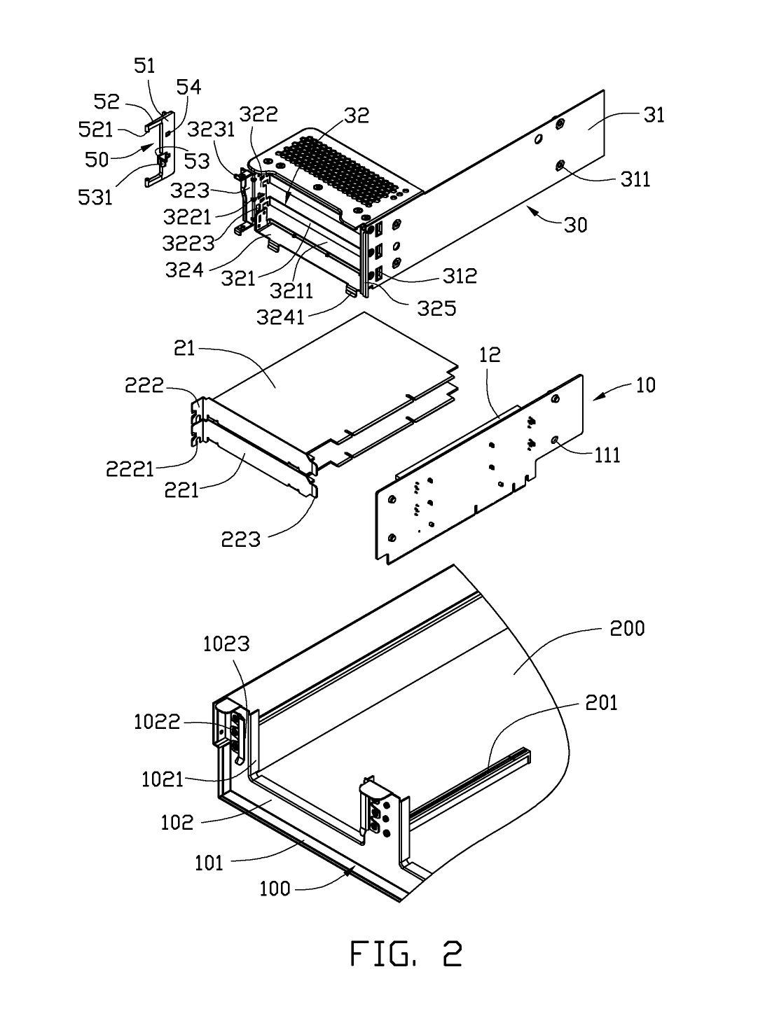

FIG. 1 to FIG. 3 show an exemplary embodiment of an electronic device. The electronic device includes an enclosure 100, a motherboard 200 received in the enclosure 100, and an expansion card module 300.

The enclosure 100 includes a bottom plate 101 and a side plate 102 perpendicularly extending up from a first side of the bottom plate 101. The side plate 102 defines a mounting slot 1021, and forms two mounting pieces 1022 at opposite sides of the mounting slot 1021. A slide slot 1023 is defined between each mounting piece 1022 and an outer surface of the side plate 102.

The motherboard 200 is mounted on the bottom plate 101. An expansion slot 201 is set on the motherboard 200.

The expansion card module 300 includes a conversion card 10, two expansion cards 20, a bracket 30, and a mounting member 50. The conversion card 10 includes a circuit board 11 and two parallel connectors 12 set on the circuit board 11. The circuit board 11 defines a plurality of mounting holes 111.

Each expansion card 20 includes a circuit board 21 and an L-shaped blocking piece 22 fixed to a first end of the circuit board 21. The blocking piece 22 includes a main piece 221 connected to the first end of the circuit board 21, a bent piece 222 perpendicularly extending outward from a first end of the main piece 221, and an engaging portion 223 extending from a second end of the main piece 221. A cutout 2221 is defined in the bent piece 222. The bent piece 222 further forms a protrusion 2222 facing the engaging portion 223.

The bracket 30 includes a main plate 31 and a seat 32 extending from a first end of the main plate 31. The main plate 31 defines a plurality of mounting holes 311 corresponding to the mounting holes 111 of the conversion card 10, and a plurality of positioning holes 312 adjacent to the seat 32.

The seat 32 includes an installing wall 321 perpendicularly extending from the first end of the main plate 31, a mounting wall 322 perpendicularly extending out from one end of the installing wall 321 away from the main plate 31, a fixing wall 323 perpendicularly extending from the mounting wall 322 away from the main plate 31, and a bottom wall 324 perpendicularly extending from a bottom side of the installing wall 321 and connected between the main plate 31 and the mounting wall 322. A flange 325 extends out from the first end of the main plate 31 opposite to the mounting wall 322.

The installing wall 321 defines a plurality of spaced openings 3211 corresponding to the positioning holes 312 and perpendicular to the main plate 31. The mounting wall 322 defines a plurality of locking holes 3221 corresponding to the openings 3211, and forms a tab 3222 adjacent to each locking hole 3221. The mounting wall 322 further defines a fixing hole 3223.

Two connecting portions 3231 extend from top and bottom ends of the fixing wall 323. Each connecting portion 3231 defines a pivot hole 3232.

Two positioning tabs 3241 extend down from a side of the bottom wall 324.

The mounting member 50 is substantially U-shaped and includes a main body 51 with a first side 511 and a second side 512. Two pivoting arms 52 extend from top and bottom ends of the first side 511. The pivoting arms 52 each form a pin 521. A latch portion 53 is formed from a middle of the first side 511. A hook 531 extends from a distal end of the latch portion 53. The main body 51 defines two spaced recessed portions 54 in a same surface as the latch portion 53. The main body 51 forms an operation portion 55 at the second side 512.

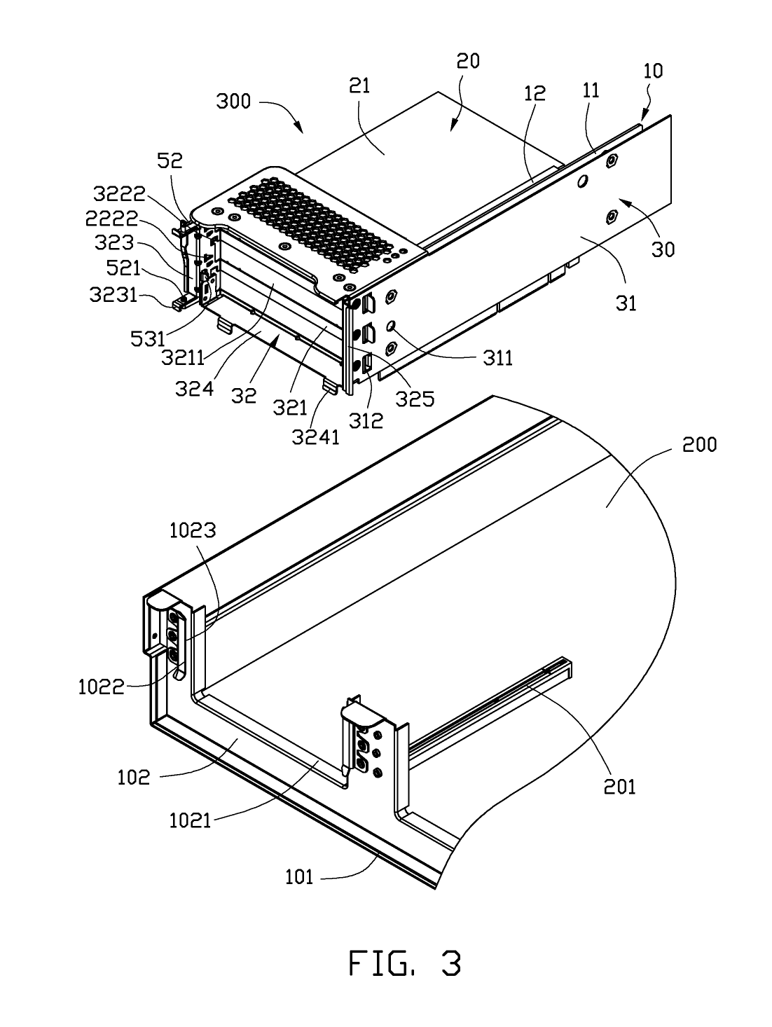

FIG. 3 shows that in assembling the expansion card module 300, the pins 521 are pivotably inserted in the pivot holes 3232, to pivotably connect the mounting member 50 to the seat 32. The conversion card 10 is fixed on the main plate 31 with a plurality of screws extending through the mounting holes 111 to screw in the mounting holes 311. The circuit boards 21 are inserted in the connectors 12. The engaging portions 223 are inserted in the positioning holes 312. The main pieces 221 shield the openings 3211. The bent pieces 222 contact with the mounting wall 322. The tabs 3222 engage in the cutouts 2221. The protrusions 2222 engage in the locking holes 3221. The operation portion 55 is operated to make the latch portion 53 engage in the fixing hole 3223. The hook 531 is locked to a sidewall bounding the fixing hole 3223. Therefore the bent pieces 222 are pressed on the mounting wall 322 by the main body 51. The recessed portions 54 are used for preventing interference with the tabs 3222.

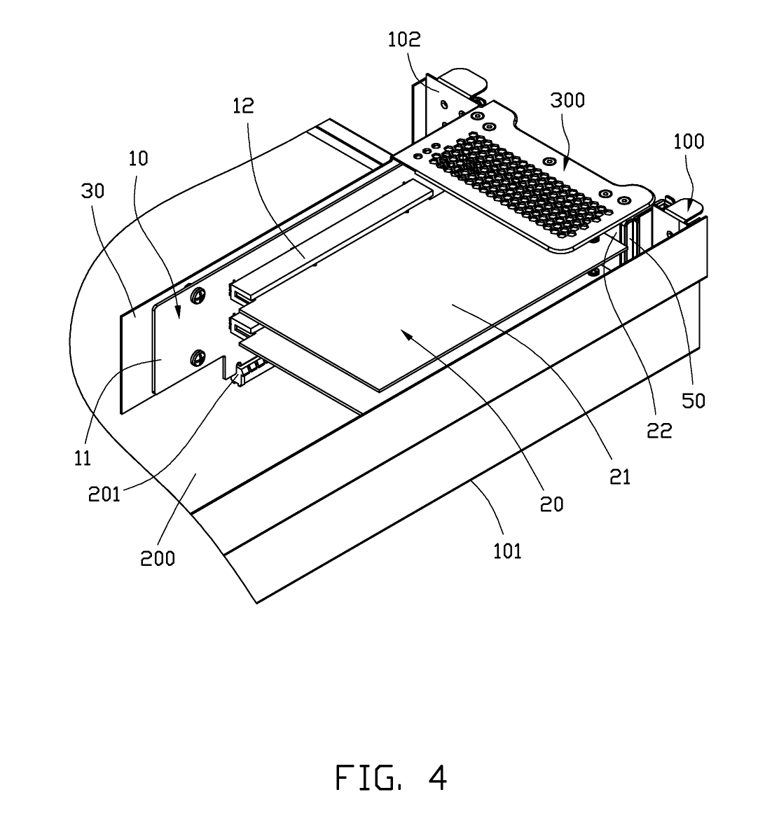

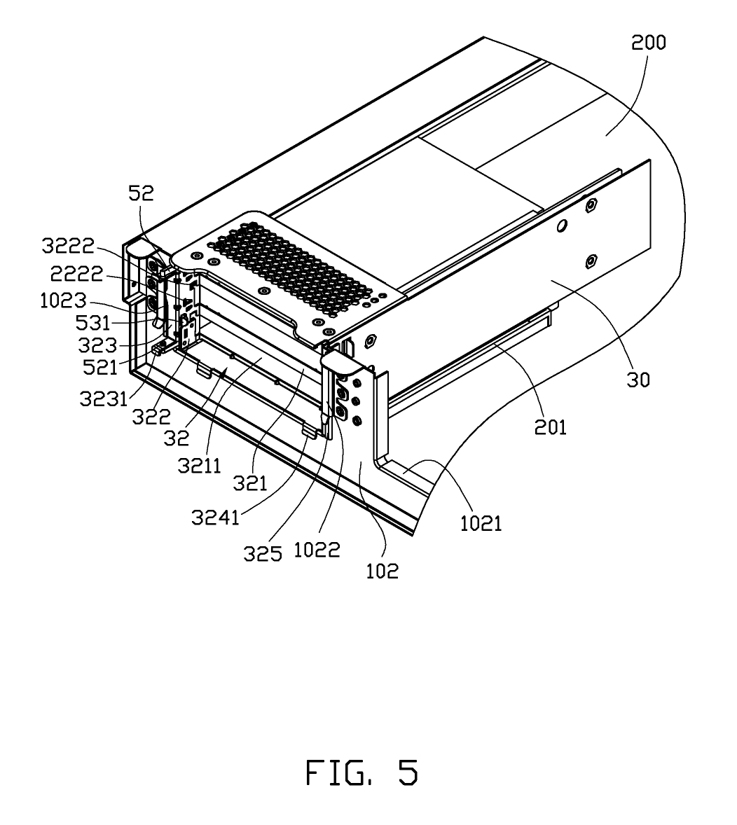

FIG. 4 and FIG. 5 show that when in assembly, when the expansion card module 300 is in the enclosure 100, the circuit board 11 is plugged in the expansion slot 201. The fixing wall 323 and the flange 325 are inserted in the slide slots 1023. The positioning tabs 3241 are blocked by the outer surface of the side plate 102, thus the expansion card module 300 is fixed in the enclosure 100.

It is to be understood, however, that even though numerous characteristics and advantages of certain embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. An expansion card module, comprising:
a bracket comprising a main plate, a seat extending from an end of the main plate, and a mounting member pivotably connected to an end of the seat away from the main plate;
a conversion card mounted on the main plate of the bracket and comprising a connector; and
an expansion card comprising a circuit board plugged in the connector of the conversion card and a blocking piece fixed on an end of the circuit board;
wherein the blocking piece is located on the seat and the mounting member presses the blocking piece on the seat.

2. The expansion card module of claim 1, wherein the seat comprises an installing wall perpendicularly extending from the end of the main plate, a mounting wall perpendicularly extending out from one end of the installing wall away from the main plate, and a fixing wall perpendicularly extending from the mounting wall away from the main plate, two connecting portions extend from opposite ends of the fixing wall, the mounting member is pivotably connected to the connecting portions.

3. The expansion card module of claim 2, wherein the blocking piece comprises a main piece, a bent piece perpendicularly extends outward from a first end of the main piece, and an engaging portion extends from a second end of the main piece, the installing wall defines an opening, the main piece shields the opening.

4. The expansion card module of claim 3, wherein the main plate defines a positioning hole adjacent to the installing wall and the engaging portion is inserted in the positioning hole.

5. The expansion card module of claim 3, wherein the bent piece contacts with the mounting wall and the mounting member presses the bent piece on the mounting wall.

6. The expansion card module of claim 5, wherein the bent piece forms a protrusion facing the engaging portion, the mounting wall defines a locking hole corresponding to the opening and the protrusion engages in the locking hole.

7. The expansion card module of claim 5, wherein the mounting wall defines a fixing hole, the mounting member comprises a main body and two pivoting arms pivotably connected to the connecting portions, a latch portion is formed from a middle of a side of the main body, the latch portion is locked to the fixing hole.

8. The expansion card module of claim 1, wherein the conversion card is parallel to the main plate and the circuit board of the expansion card is perpendicular to the conversion card.

9. An electronic device, comprising:
an enclosure comprising a bottom plate and a side plate perpendicularly extending up from a side of the bottom plate;
a motherboard mounted on the bottom plate and comprising an expansion slot; and
an expansion card module comprising:
a bracket comprising a main plate, a seat extending from an end of the main plate, and a mounting member pivotably connected to an end of the seat away from the main plate;
a conversion card mounted on the main plate of the bracket and comprising a connector; and
an expansion card comprising a circuit board plugged in the connector of the conversion card and a blocking piece fixed on an end of the circuit board;
wherein the blocking piece is located on the seat, the mounting member presses the blocking piece on the seat; and
wherein the conversion card is plugged in the expansion slot of the motherboard, the seat is fixed to the side plate.

10. The electronic device of claim 9, wherein the seat comprises an installing wall perpendicularly extending from the end of the main plate, a mounting wall perpendicularly extending out from one end of the installing wall away from the main plate, and a fixing wall perpendicularly extending from the mounting wall away from the main plate, two connecting portions extend from opposite ends of the fixing wall, the mounting member is pivotably connected to the connecting portions.

11. The electronic device of claim 10, wherein the blocking piece comprises a main piece, a bent piece perpendicularly extends outward from a first end of the main piece, and an engaging portion extends from a second end of the main piece, the installing wall defines an opening, the main piece shields the opening.

12. The electronic device of claim 11, wherein the main plate defines a positioning hole adjacent to the installing wall and the engaging portion is inserted in the positioning hole.

13. The electronic device of claim 11, wherein the bent piece contacts with the mounting wall and the mounting member presses the bent piece on the mounting wall.

14. The electronic device of claim 13, wherein the bent piece forms a protrusion facing the engaging portion and the mounting wall defines a locking hole corresponding to the opening, the protrusion engages in the locking hole.

15. The electronic device of claim 13, wherein the mounting wall defines a fixing hole, the mounting member comprises a main body and two pivoting arms pivotably connected to the connecting portions and a latch portion is formed from a middle of a side of the main body, the latch portion is locked to the fixing hole.

16. The electronic device of claim 9, wherein the conversion card is parallel to the main plate and the circuit board of the expansion card is perpendicular to the conversion card.

17. The electronic device of claim 10, wherein the side plate defines a mounting slot and forms two mounting pieces at opposite sides of the mounting slot, each of the mounting pieces forms a slide slot together with an outer surface of the side plate, a flange extends out from the end of the main plate and extends opposite to the mounting wall, the seat is received in the mounting slot, the fixing wall and the flange are inserted in the slide slots.

18. The electronic device of claim 17, wherein a bottom wall perpendicularly extending from one side of the installing wall and connected between the main plate and the mounting wall, two positioning tabs extend down from the bottom wall and are blocked by the outer surface of the side plate.
